(19) United States
(12) Patent Application Publication
(10) Pub. No.: US 2021/0395989 A1
(43) Pub. Date: Dec. 23, 2021

(54) Sani-Plunge

(71) Applicant: Andrae Lamont Kirby, SR., Warr Acres, OK (US)

(72) Inventor: Andrae Lamont Kirby, SR., Warr Acres, OK (US)

(21) Appl. No.: 17/352,302

(22) Filed: Jun. 20, 2021

Related U.S. Application Data
(60) Provisional application No. 63/041,822, filed on Jun. 20, 2020.

(51) Int. Cl. E03D 9/00; B08B 9/027

(52) U.S. Cl. CPC E03D 9/00; B08B 2209/02; B08B 9/027

(57) ABSTRACT

A toilet-unclogging device which has a frontal portion with a handle, a hollow elongated body, a tail portion with a flower-like plunge ball, and waterproof disposable barriers. The waterproof disposable barriers which are stored in the frontal portion can be moved along the inside of the hollow elongated body and be retrieved through the tail portion. The waterproof disposable barrier can be used to enclose the entire device during operation yet allowing the device to function normally. After being enclosed with the waterproof disposable barrier, the plunge ball with petal-like members in the frontal portion could be thrust into the toilet drain hole to create a seal. Together with the waterproof disposable carrier, while being moved in and out of the toilet drain hole, the device will move the clogged waste through the toilet. When the operation is completed, the used waterproof disposable barrier could be removed and disposed.

### CROSS-REFERENCE TO RELATED APPLICATIONS

This application claims the benefit of Provisional Patent Application (PPA) No. 63,041,822, filed Jun. 20, 2020 by the present Inventor, which is incorporated by reference in its entirety.

### FEDERALLY SPONSORED RESEARCH AND DEVELOPMENT

Not Applicable.

### SEQUENCE LISTING OR PROGRAM

Not Applicable

### BACKGROUND—FIELD OF THE INVENTION

This invention relates to the unclogging of toilet drains.

### BACKGROUND—DISCUSSION OF RELATED ART

### 1. Currently Available Products (Prior Arts)

There are a few types of products on the market, which attempt to solve the problem that our invention intends to address. The most common products are rubber suction-cup type devices on the end of a stick as well as rubber devices designed with bellows that are stored in various types of canisters.

Most prior arts involve the use of compressed air and the need to maintain an effective seal to push the clog through toilet pipes.

### 2. Prior Arts (Products) are not Effective Nor Convenient

The suction-cup or bellow type of devices are inadequate due to the inability to consistently provide an effective seal for the variety of toilets in the market to unclog the toilet. Moreover, it is also inconvenient due to the need to clean the device after each use or end up with dirty ring stains on the floor or a canister that contains human waste stored in the corner.

a. Ineffective Seal of Air
Most prior arts have a plunger on a stick. They are rigid in design, and do not flex to fit, thus, unable to create an effective seal as there are so many varieties of toilets. This causes splashing, and in some cases spirting, from around the failed seal. That splashing and spirting is unsanitary in itself however, the storage of these types of plungers either leave filthy rings on the floor, or hides and stores water in a container that, in most cases, contains human waste.

b. Compressed-Air Operation Creates Splashing
Both prior arts involve the use of compressed air. However, the extra pressure, especially enhanced with bellows, created is unsanitary as it greatly increases the risk of splashing and spirting. The continuous repeated use of this type of pressure could also damage piping systems over time.

c. Unsanitary Storing Conditions
The standard suction cup style plungers are often found in very unsanitary condition. They not only function poorly, but they also leave ring stains on the floor. Some existing products include a bellows-style plunger, which looks a bit like an accordion along the outer edges of its bowl. This design allows for the plastic bowl to collapse and expand much like the musical instrument does as you apply pressure and pull back. This traps waste inside, which later drips on to wherever it is sitting. The interior of the canister, where the plunger is usually stored after each use, remains a bacteria breeding ground.

### 3. This Invention Improves on Prior Arts

The Sani-Plunge is different from all these prior arts and methods. By sealing from the inside of the hole, the Sani-Plunge is more adaptable to various toilet styles.
a. The seal is more complete and therefore more secure. The complete seal, using the flower-like petals, allows for quick handling of clogs because there is no time wasted trying to line up the hole, and the suction cup stick. The motion of clearing a clog is gentle and splash free as the Sani-Plunge only requires 1-2 inches of gentle movement while in the hole.
b. This invention unclogs toilet drains without the use of compressed air or chemicals. It moves the column of water until the clog is worked free. This invention creates an airtight seal, and a way to control/move the water column. In addition, it fits all shapes of toilets and the removeable and disposable waterproof/resistant barrier means the device remains clean.
c. The removeable and disposable waterproof/resistant barrier ensure that a user will not need to directly touch a mess and the plunger remains clean and so does the environment it is in. This invention helps reduce the opportunities to be contaminated by, or to leave an area contaminated by human waste.

### SUMMARY OF THE INVENTION

The invention is a device which allows a sanitary and more effective way to unclog a toilet. The device is different from existing tools in that it uses pressure against a removeable and disposable waterproof/resistant barrier and creates a superior seal by sealing from the inside of the hole. The invention is made to be adaptable to various toilet styles. The design allows the seal to be more complete and secure. The complete seal allows for quick handling of clogs. In addition, there is no time wasted trying to line up the hole, and the suction cup stick. The motion of clearing a clog is gentle and splash free as the Sani-Plunge only requires 1-2 inches of gentle vertical movement while in the hole. The removeable and disposable waterproof/resistant barrier ensure that a user do not need to directly touch a mess and the device remains clean and so does the environment.

### DESCRIPTION OF THE DRAWINGS

FIG. 1 is a perspective view of the Sani-Plunge taken from the side.

FIG. 2 is a 3D rendering of the Sani-Plunge.

FIG. 3 is a cross-sectional top view of the lower half of the Bio Barrier Cartridge.

FIG. 4 is a perspective view of the Plunge Ball.

FIG. 5 is bottom view of the Plunge Ball showing the offset petal configuration.

FIG. 6 is a perspective view of the Pliable protrusions that protrude from the Plunge Ball.

FIG. 7 is a perspective view showing the Sani-Plunge inside a biodegradable barrier.

FIG. 8 is a perspective view showing the Sani-Plunge inside a customizable canister.

### DETAILED DESCRIPTION OF THE PREFERRED EMBODIMENT

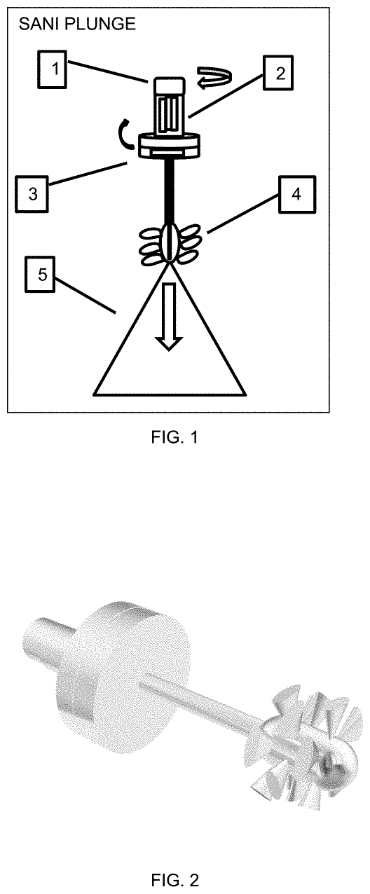

FIG. 1 is a perspective view of the Sani-Plunge, with the Sani-Plunge Plunge Ball, from the side. The Sani-Plunge (FIG. 2) can be constructed out of wood, metal, plastic or any material rigid and sturdy. The plunge ball is to be constructed of a rubber like material with the pliable protrusions offset to allow flexibility to work in conjunction with the biodegradable barrier to create a seal while plunging the toilet or any other pipe.

This view shows a representation of following items;

Item 1—The removable cap that screws on to the upper half of the Bio Barrier Cartridge (Item 2) and secures the spare rolls of Bio Barriers inside the top half of the Bio Barrier Cartridge (Item 2). This cap can be formed into limitless decorative options.

Item 2—The upper half of the Bio Cartridge contains storage for extra Bio Barriers and also acts as a handle when the plunger is put into action. The removeable cap screws on to it, where it contains the extra Bio Barriers. Half of the latching mechanism and half of the hinge assembly are also attached to this item to allow it to connect to, and open to display, the top section of Item 3, the lower half of the Bio Cartridge.

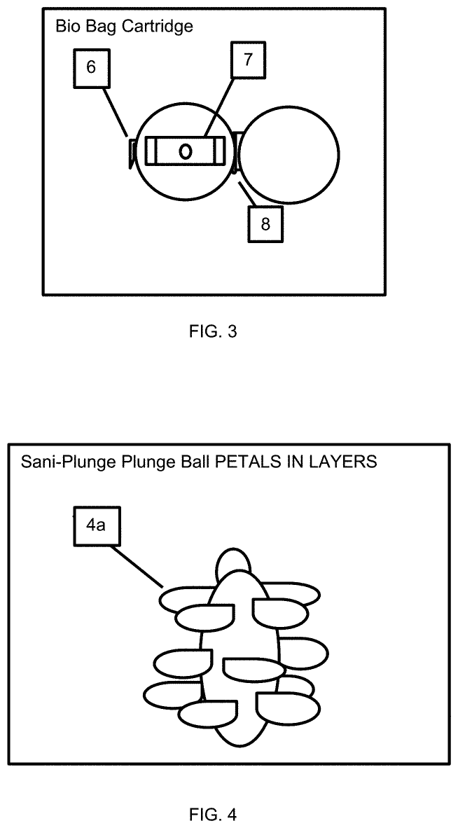

Item 3—The lower half of the Bio Cartridge (FIG. 3) contains the Bio Barrier Cradle that holds the spool of barriers. Half of the latching mechanism and half of the hinge assembly is also attached to this item to allow it to connect to Item 2. The Bio Barriers (Item 5) are fed through the hole one at a time in the center, through the shaft, through the Sani-Plunge Plunge Ball (Item 4) and out of the end of the Sani-Plunge

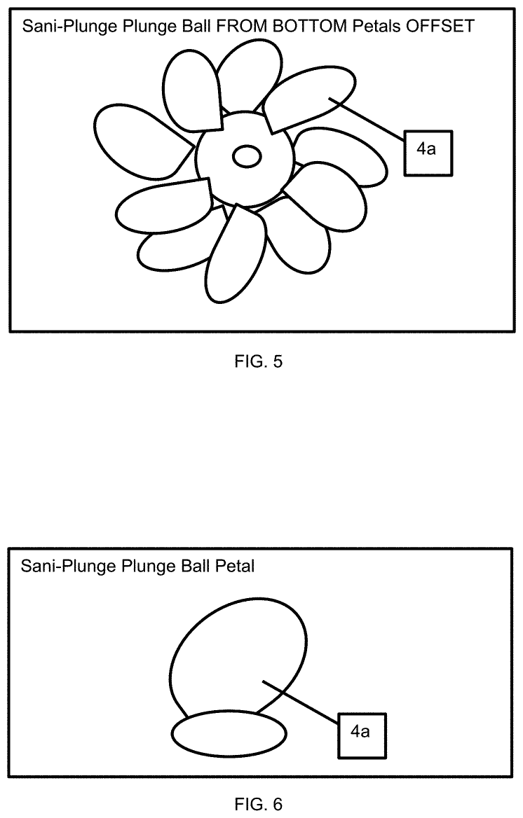

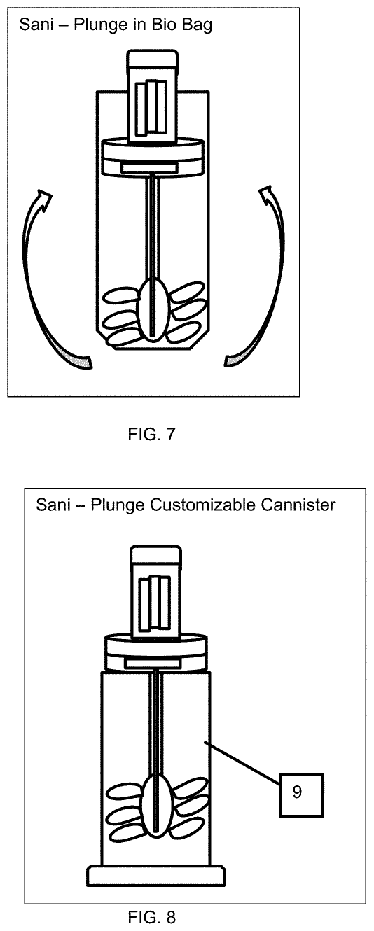

Item 4—The Sani-Plunge Plunge Ball (FIG. 4/FIG. 5) is constructed of materials with rubber characteristics. Once the Bio Barrier is pulled over the Sani-Plunge Plunge Ball and the entire apparatus (FIG. 7), the flexible pliable protrusions work in conjunction with the barrier to create a seal. Once the seal is created, the apparatus is then repeatedly gently plunged into the hole, 1-2 inches, causing the column of water to move, and free common clogs in toilets or other pipes. The barrier is then removed by inserting hands in clean side of barrier, uncovering the plunge ball, tearing off the used barrier and discarding it. The next barrier is in line and ready to use

Item 5—Biodegradable Barrier. This is a barrier from the spool of barriers housed in the Bio Barrier Cradle that has been fed through the lower half of the Bio Cartridge. Once this is pulled out far enough to expose the perforations that separate it from the next barrier and are pulled back over the Sani-Plunge Plunge Ball and the entire apparatus (FIG. 7), the flexible pliable protrusions work in conjunction with the barrier to create a seal.

FIG. 2 is a 3D rendering of the Sani-Plunge.

FIG. 3 is a cross-sectional top view of the lower half of the Bio Barrier Cartridge.

The lower half of the Bio Cartridge (FIG. 3) contains the Bio Barrier Cradle that holds the spool of barriers. Half of the latching mechanism and half of the hinge assembly is also attached to this item to allow it to connect to Item 2. The Bio Barriers (Item 5) are fed through the hole one at a time in the center, through the shaft, through the Sani-Plunge Plunge Ball (Item 4) and are pulled out of the end of the Sani-Plunge

FIG. 4 is a perspective view of the Plunge Ball.

The Sani-Plunge Plunge Ball (FIG. 4/FIG. 5) is to be constructed of materials with rubber characteristics. The pliable protrusions (Item 4a) are stacked in sets of 5. Each set of 5 pliable protrusions is offset from the sets above and or below it. Once the Bio Barrier is pulled over the Sani-Plunge Plunge Ball and the entire apparatus (FIG. 7), the flexible, offset pliable protrusions work in conjunction with the barrier to create a seal. Once the seal is created, the apparatus is then repeatedly gently plunged into the hole, 1-2 inches, causing the column of water to move, and free common clogs in toilets or other pipes. The barrier is then removed by inserting hands in clean side of barrier, uncovering the plunge ball, tearing off the used barrier and discarding it. The next barrier is in line and ready to use

FIG. 5 is bottom view of the Plunge Ball showing the offset petal configuration.

The pliable protrusions (Item 4a) are stacked in sets. Each set of pliable protrusions is offset from the sets above and or below it. Once the Bio Barrier is pulled over the Sani-Plunge Plunge Ball and the entire apparatus (FIG. 7), the flexible, offset pliable protrusions work in conjunction with the barrier to create a seal. Once the seal is created, the apparatus is then repeatedly gently plunged into the hole, 1-2 inches, causing the column of water to move, and free common clogs in toilets or other pipes.

FIG. 6 is a perspective view of the Pliable protrusions that protrude from the Plunge Ball. The pliable protrusions (Item 4a) are stacked in sets of 5. Each set of 5 pliable protrusions is offset from the sets above and or below it. Once the Bio Barrier is pulled over the Sani-Plunge Plunge Ball and the entire apparatus (FIG. 7), the flexible, offset pliable protrusions work in conjunction with the barrier to create a seal. Once the seal is created, the apparatus is then repeatedly gently plunged into the hole, 1-2 inches, causing the column of water to move, and free common clogs in toilets or other pipes.

FIG. 7 is a perspective view showing the Sani-Plunge inside a biodegradable barrier. Once the Bio Barrier is pulled over the Sani-Plunge Plunge Ball and the entire apparatus, the flexible, offset pliable protrusions work in conjunction with the barrier to create a seal. Once the seal is created, the apparatus is then repeatedly gently plunged into the hole, 1-2 inches, causing the column of water to move, and free common clogs in toilets or other pipes. The barrier is then removed by inserting hands in clean side of barrier, uncovering the plunge ball, tearing off the used barrier and discarding it. The next barrier is in line and ready to use

FIG. 8 a perspective view showing the Sani-Plunge inside the container.

This stores the Sani-Plunge when it is not in use and can be modified to customer specs to match décor.

What is claimed is:

1. A device for unclogging toilet, comprising:
(a) a hollow elongated body having a frontal portion on one end and a tail portion on the other end,
(b) a handle removably secured to said frontal portion of said hollow elongated body,
(c) a plurality of waterproof disposable barriers whereby said waterproof barriers could be put in through said frontal portion and retrieved through said tail, and
(d) a plunge ball with petal-like members removably secured to said tail portion.

2. A device as in claim 1 wherein said frontal portion and said hollow elongated body are of cylindrical shape with the said frontal portion having a greater radius than the rest of the said hollow elongated body, whereby the space enclosed by said frontal portion and said handle provides storage for said waterproof disposable barriers.

3. A device as in claim 2, further comprising a feeding element feeding said waterproof disposable barriers from said frontal portion along the length of said hollow elongated body to said tail portion.

4. A device as in claim 3, further comprising a canister to hold said hollow elongated body with said handle and said plunge ball.

5. A device as in claim 3 wherein said plunge ball is made of flexible materials such as rubber.

6. A device as in claim 3 wherein said waterproof disposable barriers are biodegradable bags.
